(19) United States
(12) Patent Application Publication
(10) Pub. No.: US 2012/0093047 A1
(43) Pub. Date: Apr. 19, 2012

(54) CORE ABSTRACTION LAYER FOR TELECOMMUNICATION NETWORK APPLICATIONS

(75) Inventors: Mohammad R. Khawer, Lake Hopatcong, NJ (US); Lina So, East Brunswick, NJ (US)

(73) Assignee: Alcatel-Lucent USA Inc. via the Electronic Patent Assignment System (EPAS)

(21) Appl. No.: 12/904,322

(22) Filed: Oct. 14, 2010

(51) Int. Cl. H04B 7/00

(52) U.S. Cl. 370/310

(57) ABSTRACT

A new sub-system, the core abstraction layer (CAL), is introduced to the middleware layer of the multi-core processor based modem board. This new module provides an abstraction for the multi-core FSL P4080 processor and its DPAA. For the deployment of this modem board, the CAL will provide various services such as zero copy lock free buffer management scheme to LTE L2 application, and the support for the new backplane Ethernet driver (BED) interface for the RLC SDU transmission and reception to and from the controller board for multi-cell configuration.

### BACKGROUND OF THE INVENTION

This invention relates to a core abstraction layer for multi-cell support on a single modem board using a multi-core processor. While the invention is particularly directed to the art of mobile telecommunications, and will be thus described with specific reference thereto, it will be appreciated that the invention may have usefulness in other fields and applications.

By way of background, LTE (Long Term Evolution) is a rapidly evolving 3GPP project that aims to improve the UMTS (Universal Mobile Telecommunications System) mobile phone standard to cope with future communication network demands. LTE improves wireless network efficiency and bandwidth, lower costs and enhance services experience. Specifically, LTE makes use of new spectrum opportunities and offer better integration with other open standards. LTE generally includes an LTE RAN (Radio Access Network) (also known as E-UTRAN) along with an EPS (Evolved Packet System, also called Evolved Packet Core).

Communication systems are generally split into two primary functions: data plane functions and control plane functions. In previous LTE products, at least two processors were used on the modem board: one to support the control plane functions (non-real time, e.g., Operations, Administration, and Management (or OA&M), and call processing management—related functionalities), and another to terminate and support the data plane functions (real time, e.g., LTE Layer 2 processing). Both the control and data planes used different operating system (OS) instances, such as Linux for the control plane and a real-time OS such as vXWorks (made and sold by Wind River Systems of Alameda, Calif.) for the data plane core. Typically, one modem board supports one sector or cell. So to support multi-cell (e.g., 3-cells or 6-cells) configurations, it would be necessary to provide as many modem boards as the number of cells.

There is need for a middleware abstraction layer that sits between the application layer and the hardware layer and de-couples the application layer from the low level hardware related functionalities.

### SUMMARY OF THE INVENTION

In the processing environment, a middleware layer typically hides all the hardware specific implementation details from an application layer. A new sub-system, the core abstraction layer (CAL), is introduced to the middleware layer of the multi-core processor-based modem board. This new module provides an abstraction for the multi-core processor and its Data Path Acceleration Architecture (or DPAA). For the deployment of this modem board, the CAL provides various services, such as a zero copy lock free buffer management scheme for LTE L2 applications, and support for the Backplane Ethernet driver (BED) interface for the Radio Link Control (RLC) Service Data Unit (SDU) transmission and reception to and from the controller board for the multi-cell configuration.

Software portability is a main objective of the CAL. It also de-couples the application layer from the low level platform services that facilitate parallel software development of the application, middleware, and platform layer services. Thus, it will be relatively easy to migrate to processors with more or less cores or even a different vendor for a multi-core processor with little or no impact on the application layer software.

In one aspect of the invention an apparatus for providing multi-cell support in a telecommunications network is provided. The apparatus includes a modem board and a multi-core processor. The processor generally includes a plurality of processor cores attached to the modem board, wherein at least one processor core is used to execute all control plane functions and the remaining processor cores are used to execute all data plane functions, and a core abstraction layer that hides any core specific details from application software running on the processor cores. The core abstraction layer includes various modules. An initialization module loads the network configuration data and static parsing, classifying and distributing (PCD) rules to one or more frame managers and sets up the core abstraction layer framework based on a set of configuration files. A buffer module may provide lock-less buffer management services for Layer 2 applications. A messaging module may provide zero-copy, and lock-less messaging services to Layer 2 software to send or receive user plane data to or from another board. A PCD module provides PCD rules and configurations to be used by the frame managers for routing ingress frames to appropriate cores. A Data Path Acceleration Architecture (DPAA) trace module provides tracing capabilities for enabling and disabling traces in a DPAA driver module.

In another aspect of the present invention, an apparatus for providing multi-cell support in a telecommunications network is provided. The apparatus includes a modem board and a multi-core processor having a plurality of processor cores attached to the modem board, wherein a single partition is defined with all of the processor cores included in it and wherein the single partition is used to execute all control plane functions and all data plane functions, and a core abstraction layer that hides any core specific details from application software running on the processor cores in the single partition. The core abstraction layer includes various modules. An initialization module loads the network configuration data and static parsing, classifying and distributing (PCD) rules to one or more frame managers and sets up the core abstraction layer framework based on a set of configuration files. A buffer module may provide lock-less buffer management services for Layer 2 applications. A messaging module may provide zero-copy, and lock-less messaging services to Layer 2 software to send or receive user plane data to or from another board. A PCD module provides PCD rules and configurations to be used by the frame managers for routing ingress frames to appropriate cores. A Data Path Acceleration Architecture (DPAA) trace module provides tracing capabilities for enabling and disabling traces in a DPAA driver module.

In yet another aspect of the present invention, a core abstraction layer for a multi-core processor is provided. The core abstraction layer includes various modules. An initialization module loads the network configuration data and static parsing, classifying and distributing (PCD) rules to one or more frame managers and sets up the core abstraction layer framework based on a set of configuration files. A buffer module may provide lock-less buffer management services for Layer 2 applications. A messaging module may provide zero-copy, and lock-less messaging services to Layer 2 software to send or receive user plane data to or from another board. A PCD module provides PCD rules and configurations to be used by the frame managers for routing ingress frames to appropriate cores. A Data Path Acceleration Architecture (DPAA) trace module provides tracing capabilities for enabling and disabling traces in a DPAA driver module.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates one embodiment of a platform architecture in accordance with aspects of the present invention;

FIG. 2 illustrates an alternative embodiment of a platform architecture in accordance with aspects of the present invention; and

FIG. 3 illustrates an exemplary architecture for implementing a core abstraction layer in accordance with aspects of the present invention.

### DETAILED DESCRIPTION

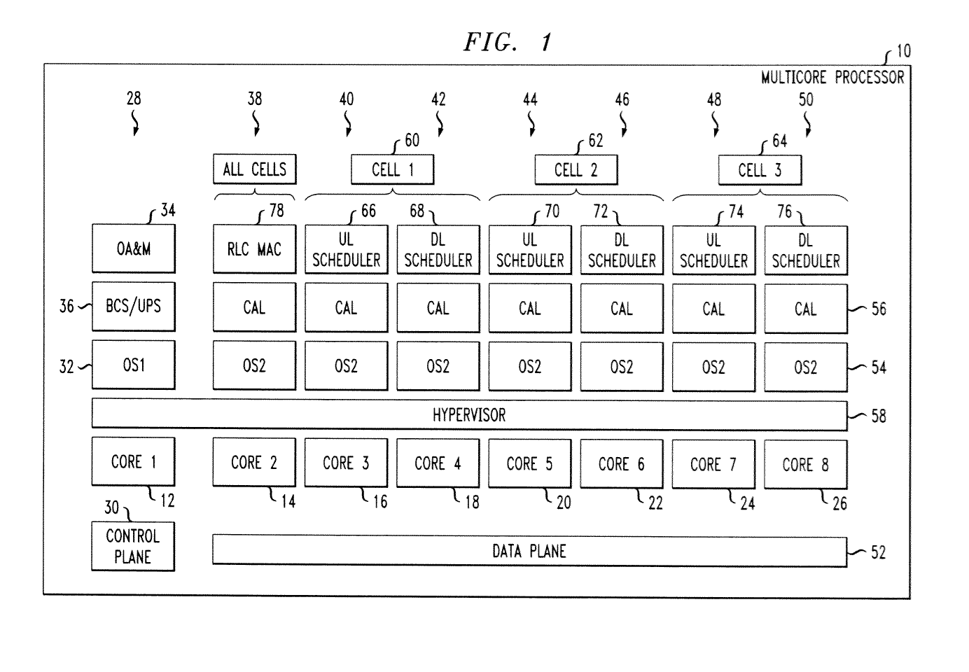

Referring now to the drawings wherein the showings are for purposes of illustrating the exemplary embodiments only and not for purposes of limiting the claimed subject matter, FIG. 1 provides a view of a system into which the presently described embodiments may be incorporated. This platform architecture is generally used on a modem board, but it is to be understood that it may be used in other applications. In this case, a multi-core processor 10 with eight cores (shown as 12, 14, 16, 18, 20, 22, 24, and 26 in the figure) is provided. It is to be appreciated, however, that the multi-core processor 10 may have any number of cores. In this example, a first partition 28 is for the control plane 30 running a first Operating System (OS1) 32. The first partition 28 also includes Operations, Administration, and Management (OA&M) 34 and BCS/UPS 36. The BCS/UPS 36 is a middleware layer that provides an abstraction for the hardware to the application software such as the OA&M entity. Seven AMP partitions (shown as 38, 40, 42, 44, 46, 48, 50 in the figure), one per each of the remaining seven cores, are for the data plane 52 with each running a second Operating System (OS2) 54.

All of the Layer 2 (L2) processing is typically performed on the seven cores of the processor. Layer 2 is the Data Link Layer of the seven-layer OSI model of computer networking. The Data Link Layer is the protocol layer that transfers data between adjacent network nodes in a wide area network or between nodes on the same local area network segment. The Data Link Layer provides the functional and procedural means to transfer data between network entities and might provide the means to detect and possibly correct errors that may occur in the Physical Layer. Examples of data link protocols are Ethernet for local area networks (multi-node), the Point-to-Point Protocol (PPP), HDLC and ADCCP for point-to-point (dual-node) connections. In this case, L2 generally refers to the L2 scheduler processing that is needed for the LTE air interface, which has very tight real time requirements.

All of the Layer 1 (L1) processing is typically performed on the DSPs and FPGAs. In particular, a core abstraction layer (CAL) 56 hides the core specific details from the L2 application software.

The exemplary architecture may further include a supervisor software entity, such as a hypervisor 58, to ensure that all these partitions run independently and do not corrupt each other (i.e., to ensure fault isolation). A hypervisor is a software program used in virtualization. It allows several operating systems to run side-by-side on a given piece of hardware. Unlike conventional virtual-computing programs, a hypervisor runs directly on the target hardware. This allows both the guest operating systems and the hypervisor to perform much more efficiently. A list of possible hypervisors includes, but is not limited to, the following types: Xen (Citrix), KVM (kernel-based virtual machine), VMware ESX/vmkernel, Microsoft Hyper-V, PowerVM (IBM), Logical Domains/Oracle VM, and Wind River Hypervisor.

In this example, the processor 10 serves three cells (shown as 60, 62, and 64 in the figure). Each cell requires an uplink (UL) scheduler (shown as 66, 70, and 74 in the figure) and a downlink (DL) scheduler (shown as 68, 72, and 76 in the figure).

It is known that the Radio Link Control (RLC) layer is used to segment, concatenate and correct errors on packet frames sent and received across the LTE air interface. The Radio Link Control and Medium Access Control (RLC/MAC) software is used in the GPRS (2.5 G) wireless stack. It provides the acknowledged and the unacknowledged data transfer between the mobile station and the base station controller (BSC). In this regard, the processor 10 further includes an RLC/MAC block 78, which is the basic transport unit on the air interface that is used between the mobile and the network. It is used to carry data and RLC/MAC signaling.

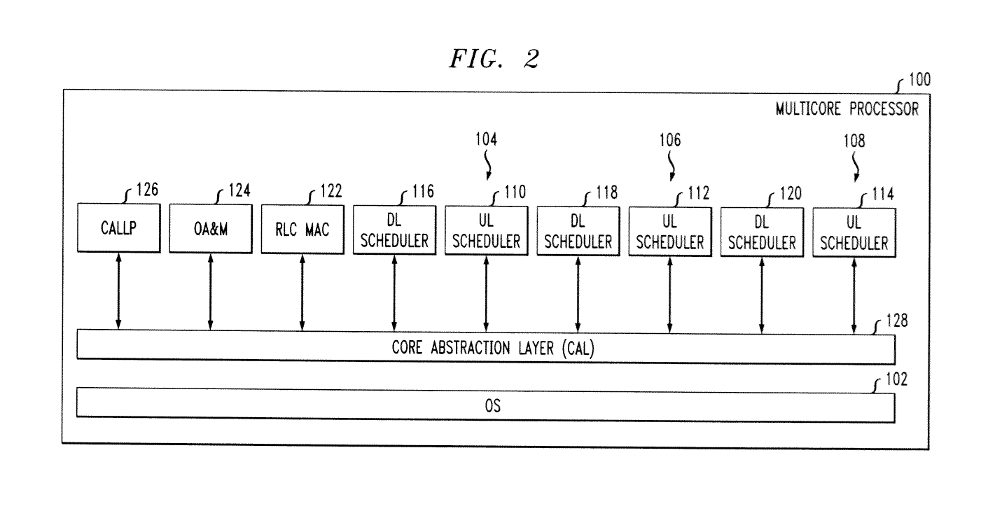

With reference now to FIG. 2, an alternative platform architecture 100 is shown. This architecture is generally used on a modem board, but it is to be understood that it may be used in other applications. In this embodiment one partition is defined with all 8 cores in it. It is to be appreciated, however, that the multi-core processor 100 may have any number of cores. With this embodiment, it is thus possible to use a single SMP OS instance 102 that runs on all of the cores (e.g., 8 cores). Since the control and data planes are now under one OS instance, care is needed to ensure that a problem with the data plane will not bring down the control plane as well.

In this example, the processor 100 serves three cells (shown as 104, 106, and 108 in the figure). Each cell requires an uplink (UL) scheduler (shown as 110, 112, and 114 in the figure) and a downlink (DL) scheduler (shown as 116, 118, and 120 in the figure). Also included is an RLC/MAC block 122, which is the basic transport unit on the air interface that is used between the mobile and the network. It is used to carry data and RLC/MAC signaling. The processor 100 also provides OA&M 124 and BCS/UPS 126.

As in the first embodiment, the processor 100 includes a core abstraction layer (CAL) 128, which hides the core specific details from the L2 application software.

To meet the real time performance needs of the base station, an OS such as SMP Linux with PREEMPT_RT patch may be used. Of course, it is to be understood that other operating systems may be used. The SMP configuration may tend to lose the deterministic behavior of the supervised AMP configuration. To achieve deterministic behavior in an SMP configuration, the system is preferably implemented in a manner that employs core reservation and core affinity constructs to achieve AMP-like system behavior. This is also desirable to get the best performance out of SMP Linux with PREEMPT_RT OS, for example. Use of lockless zero copy services, such as buffer management, and Messaging services, may also help address any latency issues that are posed by the use of SMP Linux with PREEMPT_RT OS.

One of the main functions of the core abstraction layer (56, 128) as shown in FIGS. 1 and 2 is to provide high-level applications, such as L2 processing, with various services that utilize the full capabilities of the multi-core platform. The core abstraction layer is thus designed to achieve several goals. First, it should support a BED (Backplane Ethernet Driver) DPAA-Based Interface, while hiding DPAA and multi-core specific implementation from higher-level application software (i.e., L2 software). Second, it should utilize the P4080's DPAA hardware components to provide an accelerated data path for user-plane data in both the ingress and egress directions. Third, it should provide as much flexibility as possible so to easily adapt to configuration changes (i.e., without requiring code changes). An example of a CAL configuration is a DPAA resources configuration for buffer pools, ingress frame queues, and egress frame queues.

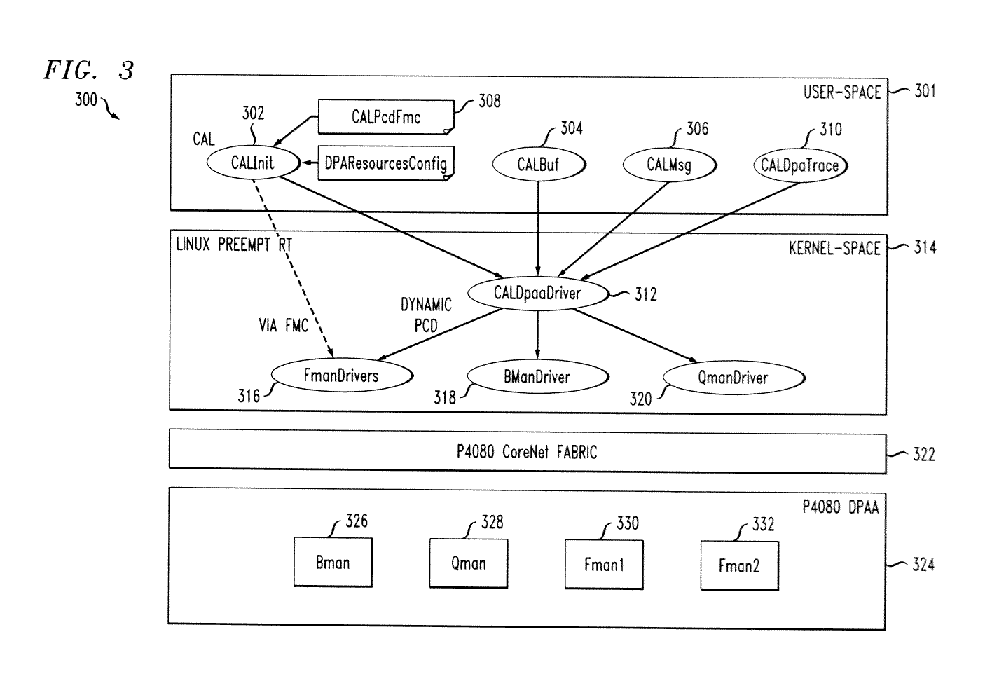

With reference now to FIG. 3, an exemplary architecture 300 that achieves these and other goals is shown. In this regard, a core abstraction layer (CAL) 301 includes various modules in user-space, including a core abstraction layer initialization (CALInit) module 302, a core abstraction layer buffer (CALBuf) module 304, a core abstraction layer messaging (CALMsg) module 306, a core abstraction layer parsing, classifying and distributing (CALPcdFmc) module 308, and a core abstraction layer DPAA trace (CALDpaaTrace) module 310. The CAL 301 may also include a kernel-space module, i.e., a core abstraction layer DPAA driver (CALDpaaDriver) 312.

The architecture 300 further includes a suitable operating system 314 such as Linux Preempt RT. The operating system 314, in turn, supports various drivers, such as the aforementioned CALDPaa driver 312, at least one frame manager (FMan) driver 316, at least one buffer manager (BMan) driver 318, and at least one queue manager (QMan) driver 320.

As shown in FIG. 3, the architecture 300 may suitably include a P4080 CoreNet fabric 322, which is an interconnect architecture suitable for scalable on-chip network to connect multiple power architecture processing cores with caches, stand-alone caches and memory subsystems.

The P4080 processor includes an implementation of the new Data Path Acceleration Architecture (DPAA). Thus, the architecture 300 may further include a P4080 DPAA 324. The DPAA 324 is designed to optimize multicore network processing such as load spreading and sharing of resources, including network interfaces and hardware accelerators. As shown, the DPAA 324 generally includes various managers such as a BMan 326, a QMan 328, and a first and second Fman 330 and 332, respectively.

The CALInit module 302 typically loads the LTE network configuration and any static PCD rules to the frame managers 330 and 332 and sets up the CAL framework based on a set of configuration files. The CALInit module 302 interfaces with an FMC (FMan Configuration Tool) (not shown) or any number of FMan API(s) (not shown) to configure the FMan PCD, and the CALDpaa driver 312 to load and setup the CAL configuration (e.g., User plane DPA resources). As used herein, the term API (or application programming interface) refers to an interface implemented by a software program, which enables it to interact with other software. It facilitates interaction between different software programs similar to the way the user interface facilitates interaction between users and computers. An API is implemented by applications, libraries, and operating systems to determine their vocabularies and calling conventions, and is used to access their services. It may include specifications for routines, data structures, object classes, and protocols used to communicate between the consumer and the implementer of the API.

The CALInit module 302 also provides a debug mechanism via LEC (Linux Error Collector) services whereby various CAL and DPAA resources statuses and statistics are collected and dumped to LEC's snapshot files for postmortem investigation.

It is known that in a wireless multiple-access communication system, transmitters and receivers may communicate using a multiple layer communication stack. The layers may include, for example, a physical layer, a medium access control (MAC) layer, a radio link control (RLC) layer, a protocol layer (e.g., packet data convergence protocol (PDCP) layer), an application layer and so on. The RLC layer receives service data units (SDU) from the PDCP layer, and concatenates or segments the SDUs into RLC protocol data units (PDU) for transmission to the MAC layer.

Accordingly, the CALBuf module 304 provides lock-less buffer management services for L2 applications for use in the RLC SDU processing. As known in the art, a non-blocking algorithm ensures that threads competing for a shared resource do not have their execution indefinitely postponed by mutual exclusion. A non-blocking algorithm is lock-less (or lock-free) if there is guaranteed system-wide progress. The CALBuf module 304 also supports query for buffer pool statistic data (e.g., pool depletion state, depletion count, pool availability state, pool allocation error count, etc). The CALBuf module 304 interfaces with the CALDpaa driver 312 to implement the services. The CALBuf module 304 provides a lock-less buffer management scheme that is extremely critical for proper system operation in a multi-core environment, where a lock taken by a non-real time process may cause latency issues for a real time process waiting for the release of that lock.

The CALMsg module 306 provides services to receive (ingress) RLC SDUs and send (egress) RLC SDUs via DPAA. The CALMsg module 306 also supports query for Tx/Rx Ethernet interface statistic data (e.g., number of FDs received or transmitted, number of FDs dropped, various types of bad FDs, etc. The CALMsg module 306 interfaces with the CALDPaa driver 312 to implement the services. The CALMsg module 306 provides a zero-copy lock less messaging service to the LTE L2 application to send or receive TCP/UDP IP packets without the use of the protocol stack. This is needed to ensure that the application software will not encounter un-bounded latency spikes that can break down the proper system behavior of the LTE system, which has very strict real time processing requirements.

The CALPcdFmc module 308 provides Parsing, Classification and Distribution (PDC) rules and configurations to be used by each FMan (330, 332) for routing ingress frames to appropriate cores.

The CALDPaaTrace module 310 provides tracing capabilities for enabling and disabling traces in the CALDpaaDriver 312. The CALDPaaTrace module 310 interfaces with the CALDpaa driver 312 to implement such services.

The CALDpaaDriver 312 is the kernel-space component of the CAL 301, and this driver helps implement and provide buffer management services and messaging services using Bman and Qman APIs. The CALDpaaDriver 312 is responsible for managing DPAA resources (buffer pools and frame queues) to be used for user-plane data distributing; providing user-space interface to other CAL modules via various file operations such as open, release, i-o-control (ioctl) for initialization, buffer management, and messaging services; performing kernel-user space (K-U) buffer mapping; providing DPAA buffer pool and receiver and transmitter statistical data; and implementing services for managing ring buffers. It should be noted that ring buffers represent the CAL's L2 software queue and are used to store FDs destined for a specific L2 DLT. The CALMsg module 306 provides APIs for L2 to retrieve buffer descriptors from a ring.

All of the CAL components described above are generally platform middleware (running in user-space), with the exception of the CALDpaaDriver 312. The CALDpaaDriver 312 is a custom driver that runs in kernel-space, and it is designed to implement and provide services needed by the CAL user space middleware—in particular those services that depend on the P4080 DPAA hardware components.

The CALInit module 302 is responsible for providing various functionalities. For the master core at startup, the CALInit module 302 sets up a CAL framework to support “fast path” processing. This step may include initializing the CALDpaaDriver 312, which in turn would (a) create various DPAA resources needed to process user-plane data (e.g., buffer pools, FQs (or frame queues) and (b) create CAL infrastructure needed to support buffer management and messaging services via DPAA (e.g., internal tables that maintain buffer pool configuration, FQs, and association between ingress FQs and DLT IP addresses, etc.). The CALInit module 302 also loads LTE FMC's (static) PCD rules and network configurations.

For the master core and user-plane cores (where L2 DLT and L2 uplink scheduler threads are bound to) at startup, the CALInit module 302 performs, registers and attaches the CAL 301 with LEC. This provides the LEC's snapshot task with a routine to call when a process terminates abnormally (e.g., LEC critical error raised). This routine collects various CAL and DPAA data, including buffer pool statistics and Tx/Rx Ethernet interface statistics, and dumps the data to LEC's snapshot files for debug purposes.

The CALBuf module 304 provides buffer management services to be used exclusively for “fast path” data processing. The CALBuf module 304 provides user-space APIs to L2 application. The CALBuf module 304 collaborates with the CALDpaaDriver 312 to provide zero copy and lock-less buffer management service for buffers that the CALDpaa driver 312 creates but are managed by the Bman 326.

The CALBuf module 304 implements and provides APIs that support the following services, among others:
1. Acquiring a buffer, given a buffer size;
2. Acquiring a given number of buffers of a given size, and then returning a list of available buffers, up to the requested number of buffers;
3. Releasing a specified buffer;
4. Releasing a list of buffers; and
5. Querying for buffer pool statistics.

The CALMsg module 306 provides messaging services to L2 software to send and receive user-plane data to or from another board (i.e., eCCM). The CALMsg module 306 generally interfaces with the CALDpaaDriver 312 to provide lock-less zero copy messaging services via DPAA. This feature allows the L2 application software to send and receive TCP/UDP IP packets without the use of a protocol stack to avoid un-bounded latency delays.

The CALMsg module 306 implements and provides APIs that support various services, such as the ones described in the following paragraphs.

One possible service is registration of (L2) application entities with the CALMsg service whereby an entity can receive incoming packets via “fast path.” During this registration process, a CAL's L2 software queue (a ring buffer) is created to maintain received buffer descriptors destined for the entity. Also during this registration, the CALMsg module 306 creates an association between the ingress FQ to the IP address and ring ID for later reference(s) in other processing (e.g., determining what ring buffer to push a buffer descriptor to when a frame arrives on a FQ), performs kernel to user-space mapping of relevant buffer pools, and configures PCD rule for the application entity (if not yet done via static rules). Further, at the beginning of registration process, the CAL 301 implements a defense strategy for ensuring that all buffers acquired by application are properly released when a thread crashes.

A second service is retrieving a frame destined for the application entity. It is expected that the returned buffer address would point to the start of payload that starts with the Ethernet header.

A third service is sending a message to an external entity via DPAA on the Ethernet interface configured for processing User plane data (e.g., eth0). It is expected that L2 populates all headers (Ethernet, IP, UDP) needed; and the hardware would be properly configured to generate and populate IP checksum and UDP checksum.

A fourth service is querying for receiver and transmitter port statistical data.

A fifth service is deregistering an application entity from the CALMsg module 306. Once an application entity is deregistered, it will no longer be able to receive packets via the “fast path.” As part of the deregistration process, CAL will release all buffers acquired by the application software. For the case where the CALMsg module 306 is used to receive frames via fast path, the associated ring buffer and PCD rule will also be removed.

The CALPcdFmc module 308 provides at least a network interface configuration file and Parsing, Classifying, and Distributing (PCD) rules that the CAL 301 can use to initialize and configure the PCD components of the FMan (330, 332). The FMan's PCD components need to be configured to allow distribution of incoming frames to appropriate cores.

Described below is an example of a strategy that can be used to define LTE PCD rules (either statically or dynamically) with the exemplary architecture.

With regard to user-space distribution, all frames that arrive at the user-space Ethernet interface (eth0) with IP and UDP headers will go through a coarse classification (by the Fman). This can be achieved via provisioning of appropriate PCD rules (either statically or dynamically). Exact match distribution scheme can be used to map whole or part of a destination IP address (depending on which part of destination IP addresses can be statically defined) to a specific core. Any unmatched frames will be, by default, enqueued to a FQ that is assigned to a control plane core (i.e., core0).

With regard to default distribution, all frames that arrive at the control plane Ethernet interface (eth1) or the Debug Ethernet interface (eth2) will be distributed to the control-plane core (i.e., core0).

How and when PCD rules are defined and configured in the Fman depends on whether the PCD rules can be predefined and configured during Platform initialization. Since the IP addresses of L2 (Downlink) threads and their bindings to the various cores cannot be determined up front, it is not possible to define the Fman's PCD rules for the ingress (downlink) user-plane path during the board startup and initialization. Therefore, the PCD rules for the user-plane data path need to be defined at runtime after a cell is configured. A downlink scheduler (DLT) IP address and the core that the thread is bound to are generally known when the DLT is registered with the CALMsg module 306. On the other hand, the dispatching rules for control plane and debug traffic are straightforward and do not depend on any variant. Therefore, the PCD rules for control plane and debug plane traffic can be defined statically and configured during initialization.

The PCD rules for the control plane Ethernet interface and for the debug Ethernet interface can be defined up front and configured when the (FSL) Ethernet driver is initialized. For the user-plane Ethernet interface, the PCD rules need to be defined and configured at runtime after a DLT is up with a known IP address and binding core.

The CALDPaaTrace module 310 provides various services to enable and disable tracing and debugging on the CALDpaa driver 312 and the various P4080 DPAA components (drivers). These services include, for example, (1) enable and disable CALDpaa driver Trace, (2) enable and disable Bman Trace (Future), (3) enable and disable Qman Trace (Future), and (4) enable and disable Fman Trace (Future).

There are various scenarios in which the CAL 301 may be used. For example, the CAL 301 may support the master core at initialization (i.e., during the platform's startup):
1. Set up the CAL's framework by loading the CAL configuration data (e.g., DPAA resources configuration) and initializing the CALDpaa driver 312.
2. Load the LTE FMC's network interface configuration and static PCD rules, if any.

The CAL 301 may also support user-space processes at initialization. In that case, when the CAL 301 is loaded and initialized, the CAL 301 registers or attaches itself with LEC, providing a routine to the LEC's snapshot task to run when a process terminates. This routine will collect various statistic data related to Bman-managed buffer pools and Tx/Rx Ethernet interfaces and dump the data to LEC snapshot files for a postmortem investigation.

The CAL 301 may also support the sending of packets (i.e., L2 ULU software processing):
1. The ULU (Uplink Scheduler) registers itself with the CALMsg 306 so it can send packets via DPAA.
2. The ULU allocates a buffer using CALBuf services.
3. The ULU populates the buffer with the data to be sent with all required headers (Ethernet/IP/UDP) and payload.
4. The ULU sends the message to a destination entity via DPAA using CALMsg services.

The CAL 301 may also support the receiving of packets (i.e., L2 DLT software processing):
1. The DLT (Downlink Scheduler) registers itself with the CALMsg 306 so it can receive packets via DPAA.
2. After some delta T time (i.e., 1 ms), the DLT reads frames destined for it using CALMsg services.
3. For each frame that the DLT reads, the DLT processes the frames and releases the buffer back to the CAL 301 or the Bman 326 using CALBuf services.

It is assumed that for all scenarios that result in deleting a cell, the L2 DLT and ULU threads will perform the necessary cleanup before they are terminated. As part of the cleanup, the L2 DLT and ULU threads should deregister themselves from the CAL 301. As part of the deregistration process, the CAL 301 needs to perform some cleanup work such as releasing all buffers that an application has acquired (either directly via CALBuf services or implicitly acquired by the FMAN 330 or 332), and deleting associated ring buffer and removing PCD rule (relevant for fast path's receiver only).

The ULU and the DLT can deregister themselves from the CAL 301 using CALMsg services.

In the event that a L2 DLT or L2 ULU thread abnormally terminates (e.g., crashes), the CAL 301 may provide a debugging mechanism whereby various CAL and DPAA resources, such as buffer pool statistics and Tx/Rx Ethernet interface statistics, are collected and dumped via LEC's services.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. In a multi-core processor, a core abstraction layer comprising:
an initialization module that loads the network configuration data and static parsing, classifying and distributing (PCD) rules to one or more frame managers and sets up the core abstraction layer framework based on a set of configuration files;
a buffer module that provides lock-less buffer management services for one or more Layer 2 applications;
a messaging module that provides zero copy and lock-less messaging services to Layer 2 software to send or receive user plane data to or from another board;
a PCD module that provides PCD rules and configurations to be used by the frame managers for routing ingress frames to appropriate cores; and
a Data Path Acceleration Architecture (DPAA) trace module that provides tracing capabilities for enabling and disabling traces in a DPAA driver module.

2. The core abstraction layer of claim 1, wherein the buffer module implements and provides lock-less application programming interfaces that support one or more of the following services:
acquiring a buffer;
acquiring a given number of buffers of a given size and then returning a list of available buffers up to the requested number of buffers;
releasing a specified buffer;
releasing a list of buffers; and
querying for buffer pool statistics.

3. The core abstraction layer of claim 1, wherein the initialization module, the buffer module, the messaging module, the PCD module, and the DPAA trace module operate in user-space.

4. The core abstraction layer of claim 1, wherein the DPAA driver module operates in kernel-space.

5. The core abstraction layer of claim 1, wherein the DPAA driver module is operative to provide one or more of the following functions:
manage DPAA resources including buffer pools and frame queues to be used for user-plane data distributing;
provide user-space interface to the other CAL modules via file operations such as open, release, i-o-control for initialization, buffer management, and messaging services;
perform kernel to user-space buffer mapping;
provide DPAA buffer pool and receiver and transmitter statistical data; and
implement services for managing ring buffers.

6. An apparatus for providing multi-cell support in a telecommunications network, the apparatus comprising:
a modem board; and
a multi-core processor including a plurality of processor cores attached to the modem board, wherein at least one processor core is used to execute all control plane functions and the remaining processor cores are used to execute all data plane functions, and a core abstraction layer that hides any core specific details from application software running on the processor cores,
wherein the core abstraction layer comprises one or more of the following modules:
an initialization module that loads the network configuration data and static parsing, classifying and distributing (PCD) rules to one or more frame managers and sets up the core abstraction layer framework based on a set of configuration files;
a buffer module that provides lock-less buffer management services for one or more Layer 2 applications;
a messaging module that provides zero-copy and lock-less messaging services to Layer 2 software to send or receive user plane data to or from another board;
a PCD module that provides PCD rules and configurations to be used by the frame managers for routing ingress frames to appropriate cores;
a Data Path Acceleration Architecture (DPAA) trace module that provides tracing capabilities for enabling and disabling traces in a DPAA driver module.

7. The apparatus of claim 6, wherein the initialization module, the buffer module, the messaging module, the PCD module, and the DPAA trace module operate in user-space.

8. The apparatus of claim 6, wherein the DPAA driver module operates in kernel-space.

9. The apparatus of claim 8, wherein the DPAA driver module is operative to provide one or more of the following functions:
manage DPAA resources including buffer pools and frame queues to be used for user-plane data distributing;
provide user-space interface to the other CAL modules via file operations such as open, release, i-o-control for initialization, buffer management, and messaging services;
perform kernel to user-space buffer mapping;
provide DPAA buffer pool and receiver and transmitter statistical data; and
implement services for managing ring buffers.

10. The apparatus of claim 6, wherein the multi-core processor is configured to include a supervisor software entity for fault isolation.

11. The apparatus of claim 6, wherein the multi-core processor is configured to serve three cells in the telecommunications network, each cell having a corresponding uplink scheduler and a corresponding downlink scheduler.

12. The apparatus of claim 6, wherein the multi-core processor has eight processor cores.

13. The apparatus of claim 6, wherein the first processor core runs a first operating system and the remaining processor cores each run a second operating system.

14. An apparatus for providing multi-cell support in a telecommunications network, the apparatus comprising:
a modem board; and
a multi-core processor comprising a plurality of processor cores attached to the modem board, wherein a single partition is defined with all of the processor cores included in it and wherein the single partition is used to execute all control plane functions and all data plane functions, and a core abstraction layer that hides any core specific details from application software running on the processor cores in the single partition,
wherein the core abstraction layer comprises one or more of the following modules:
an initialization module that loads the network configuration data and static parsing, classifying and distributing (PCD) rules to one or more frame managers and sets up the core abstraction layer framework based on a set of configuration files;
a buffer module that provides lock-less buffer management services for one or more Layer 2 applications;
a messaging module that provides zero-copy and lock-less messaging services to Layer 2 software to send or receive user plane data to or from another board;
a PCD module that provides PCD rules and configurations to be used by the frame managers for routing ingress frames to appropriate cores;
a Data Path Acceleration Architecture (DPAA) trace module that provides tracing capabilities for enabling and disabling traces in a DPAA driver module.

15. The apparatus of claim 14, wherein the initialization module, the buffer module, the messaging module, the PCD module, and the DPAA trace module operate in user-space.

16. The apparatus of claim 14, wherein the DPAA driver module operates in kernel-space.

17. The apparatus of claim 16, wherein the DPAA driver module is operative to provide one or more of the following functions:
manage DPAA resources including buffer pools and frame queues to be used for user-plane data distributing;
provide user-space interface to the other CAL modules via file operations such as open, release, i-o-control for initialization, buffer management, and messaging services;
perform kernel to user-space buffer mapping;
provide DPAA buffer pool and receiver and transmitter statistical data; and
implement services for managing ring buffers

18. The apparatus of claim 14, wherein the multi-core processor is configured to serve at least three cells in the telecommunications network, each cell having a corresponding uplink scheduler and a corresponding downlink scheduler.

19. The apparatus of claim 14, wherein the multi-core processor has eight processor cores.

20. The apparatus of claim 14, wherein a single operating system instance runs on all of the cores and comprises SMP Linux with PREEEMPT_RT.
